(19) United States
(12) Patent Application Publication
(10) Pub. No.: US 2005/0177282 A1
(43) Pub. Date: Aug. 11, 2005

(54) Energy saving vending machine and control

(76) Inventor: Paul L. Mason II, Inwood, VA (US)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 10/977,936

(22) Filed: Nov. 1, 2004

Related U.S. Application Data
(60) Provisional application No. 60/536,732, filed on Jan. 16, 2004.

(51) Int. Cl. B65H 1/00; G07F 11/00; B65G 59/00; G05D 23/00

(52) U.S. Cl. 700/300

(57) ABSTRACT

A method of controlling a vending machine, the vending machine having at least two operating modes including a normal operating mode in which items to be vended are maintained at or near a desired vend temperature and an energy saving mode in which items to be vended are allowed to be at a temperature other than the desired vend temperature, the method includes collecting historical operational data about the vending machine; predicting, based at least in part on the collected historical data, at least one period of potential vend activity; and putting the vending machine into normal operating mode prior to any predicted period of potential vend activity.

### RELATED APPLICATIONS

This application is related to, and claims priority from, provisional patent application Ser. No. 60/536,732, titled “Energy Saving Vending Machine Control,” filed Jan. 16, 2004, the contents of which are incorporated herein by reference.

### FIELD OF THE INVENTION

This invention relates to vending machines, and, more particularly, to the control of energy drawing components of the machine to conserve energy.

### BACKGROUND AND SUMMARY

Vending machines are pervasive, and are used to vend all sorts of commodities (ranging from candies, snack foods and soft drinks to non-perishables), in all sorts of locations. In many cases, the commodity being vended needs to be kept (stored) within certain temperature and humidity ranges. For example, chocolates cannot be allowed to get too warm or they will melt. Similarly, perishables such as milk need to be kept cool. In addition to having storage requirements, many products are preferably vended within certain temperature ranges, for example, sodas are preferably vended cold. For these and other reasons, it is desirable to maintain the storage part of a vending machine within a certain temperature range.

The problems of maintaining contents of a vending machine within desired environmental ranges (for example, for temperature, humidity and the like) are exacerbated by the fact that vending machines may be located in many different types of physical environments, and may therefore be exposed to ranges of temperatures, humidity, light and other environmental effects. For example, the same type of vending machine may be located inside a building or outside a store, and a machine located outdoors may be in direct sunlight or in the shade.

Methods are known for controlling energy consumption in vending machines. Such methods typically control vending machines so that they operate in either a mode in which the contents are stored at a desired storage or vend temperature or an energy saving mode in which certain components are turned down or off. For instance, in a refrigerated vending machine, in the normal operating mode, a compressor and fan may be controlled to operate to keep the temperature of a storage compartment of the machine within a desired temperature range for storing and serving the refrigerated product. In an energy saving mode, on the other hand, the temperature of the storage compartment is allowed to rise to a predetermined temperature range higher than the normal operating temperature range, for example, by controlling the compressor and fan to operate less frequently, thereby saving energy. Other energy consuming components, such as lighting, other fans, heating units, and other power consuming components, may also be switched between modes.

Known vending machines can be switched between their so-called normal operating mode and their energy saving mode based on various factors, such as, for example, the day and time of day, detection of occupancy around the vending machine by an occupancy detector, or by a customer inserting money into the machine. However, in known vending machines, the switch between modes is either made manually or at preset or predetermined times or when occupancy is detected (or not detected), once the machines are situated.

It is an object of the present invention to reduce power consumption of a vending machine during inactive periods.

It is a further object of the present invention to reduce power consumption of a vending machine during inactive periods while serving products at an ideal temperature with a high degree of reliability during active periods.

It is a further object of the present invention to use historical vend data of a vending machine to determine when the machine can be set in an energy saving mode.

It is a further object of the present invention to periodically update historical vend data of a vending machine with new vend data to determine whether a scheduling for an energy saving mode for the machine should be altered.

It is a further object of the present invention to periodically update historical vend data of a vending machine by eliminating aged vend data from the historical vend data to determine whether a scheduling for an energy saving mode for the machine should be altered.

### BRIEF DESCRIPTION OF THE DRAWINGS

The invention is better understood by reading the following detailed description with reference to the accompanying drawings in which:

FIG. 1 is a block diagram of a typical vending machine according to embodiments of the present invention;

FIG. 2 depicts a logical structure of the data collected; and

FIG. 3 is a flowchart showing operation of embodiments of the present invention.

### DESCRIPTION OF PRESENTLY PREFERRED EXEMPLARY EMBODIMENTS

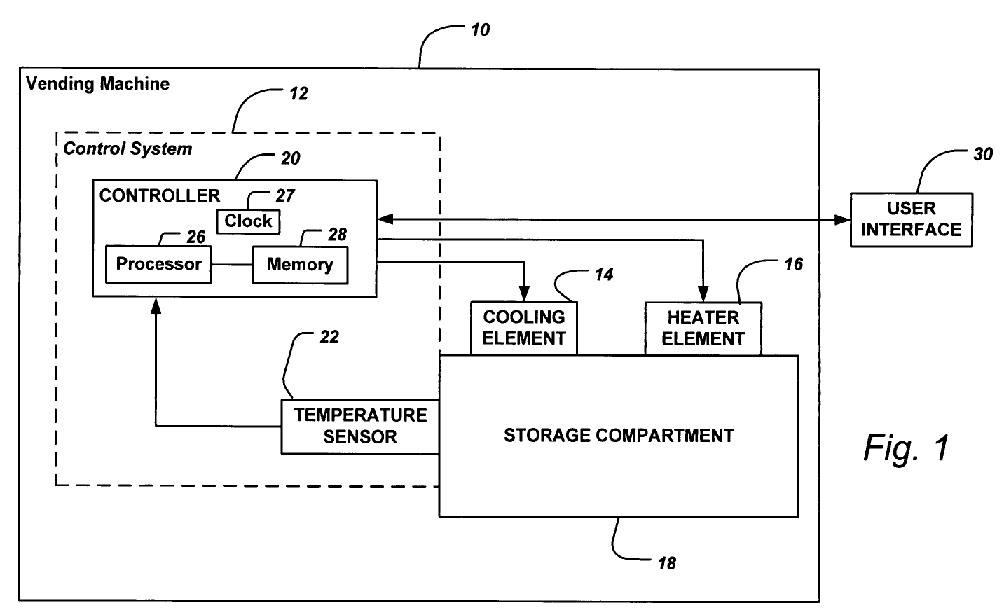

FIG. 1 depicts a block diagram of a typical vending machine according to some embodiments of the present invention. As shown in the figure, a vending machine 10 is controlled by a control system 12 which controls the operation of various components including a cooling element 14 and a heater element 16 which control the temperature of a storage compartment 18. The cooling element 14 is operatively connected to the storage compartment and may be based, for example, on a vapor compression refrigeration cycle including a refrigeration fluid compressor and its associated components. The heater element 16, if provided, is operatively connected to the storage compartment 18 and may, for example, be a silicon heater bonded to a metal mounting bracket. One skilled in the art would understand that any appropriate type of cooling and/or heater element(s) may be used. Additionally, in some environments only one of the elements, typically only a cooling element, may be used.

The control system 12 comprises a controller 20 and one or more sensors (for example, temperature sensor 22). The controller 20 includes a processor 26 and associated memory 28. In some embodiments the controller may be based, for example, on an Atmel TS87C51U2 processor with analog-to-digital inputs being used to receive signals from the sensors 22. The temperature sensor 22 (for example, a thermistor such as that available from Omega Engineering, Inc.) is used to sense the internal temperature of the storage compartment 18 of the vending machine 10. One skilled in the art will realize that other processors and sensors would be suitable for implementing this invention. Other sensors may be used to sense the external temperature of the vending machine, aspects of the ambient light, humidity and the like.

The memory 28 may be, for example, RAM or ROM (EPROM) memory or a combination thereof for storing an operating system, control programs and various operating parameters for the processor 26.

Items to be vended are stored within the vending machine 10 in the storage compartment 18. Once an item is selected and paid for (using, for example, any standard selection and payment mechanism(s), not shown), the item is vended to the requesting customer. If items in the storage compartment have been allowed to warm up to a temperature higher than their preferred vend temperature, they should be cooled before being vended. For example, if sodas are best vended cold (at a temperature of about 34 degrees Fahrenheit), then, if they are warmer than that (or colder than that), their temperature should be brought into that desirable vend temperature range prior to vending.

In one aspect, the present invention provides a method for controlling a machine, and particularly a vending machine to reduce power consumption of the machine during inactive periods by predicting such inactive periods using historical vend data. In preferred embodiments, this historical vend data is from the machine itself, although it may be obtained from another machine or from other measuring devices and provided to the machine. The control method can be either included as part of the original vending machine controller software or added on after the machine has been in service. The method of the present invention differs from other energy-saving software programs and control methods by its use of historical data. Further, the present invention uses historical data that is continuously collected and reviewed to determine patterns of vendor inactivity and/or activity. By basing an energy-saving time period, at least in part, on vend history, lower power consumption can be obtained while still effectively predicting and controlling when the machine's products should be returned to their ideal temperature before a customer arrives and selects a product for vending.

Once a pattern of inactive and active periods has been determined through analysis of vending history of the machine, the vending machine's operating parameters may be altered to reduce energy consumption during the inactive periods. Examples of parameters that can be changed include the temperature, state of the lighting, fans and/or other power-consuming components.

The software can be tailored to fit any number of operating environments and circumstances by allowing initial information required for the logic to be pre-programmed. These variables include:

The high and/or low temperature settings or a temperature differential setting of the vendor while in the so-called “energy saving” mode.

The time period (of past activity) that the controller uses for predicting future activity.

The resolution, that is, how often the controller checks for activity. The resolution is also the time increment of the historic activity data.

The offset (or lead) time which, preferably, is the time period required to change the temperature of the vendible commodity from its “non-energy saving” temperature to its “energy saving” temperature, and vice versa.

The pattern time which is how often patterns (routines) typically repeat (1 week or 7 days is most common).

The values for the above times can be zero, as well as having the option to not use the energy saving program.

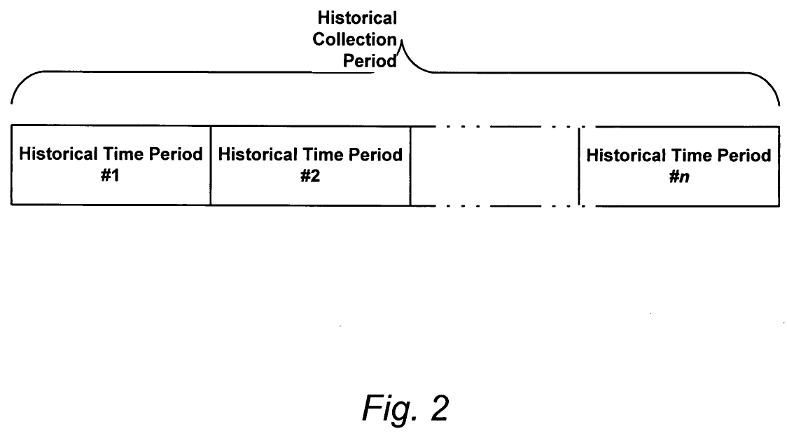

Once programmed for reduced-energy operation, the vending machine 10 begins accumulating usage data. FIG. 2 depicts a logical structure of the data collected by the machine and stored in the memory 28. In some embodiments, the historical collection period is divided into a number of historical time periods. For example, the historical collection period may be three weeks and each historical time period may be one hour. In preferred embodiments, vend and other data are collected in a rolling fashion, so that the data stored is always for the most recent historical collection period. The data for the historical collection period are stored in the memory 28 of the controller.

In some preferred embodiments, the historical data stored include whether or not a vend occurred for a particular time or time period. In these cases, the stored data may be a simple Boolean value. In some situations, when the power is out, a vend might have occurred had there been power. Accordingly, in cases where the power was out, the system controller will generally assume that a vend occurred.

When a sufficient historical time period has been established, the vending machine begins applying the energy saving logic by attempting to predict current vending activity based, at least in part, on the collected historical data. If, for instance, either an active historical period is encountered, or optionally, current activity is evident (that is, if someone vends a selection), the logic defaults back to the standard non-energy-saving parameters or states.

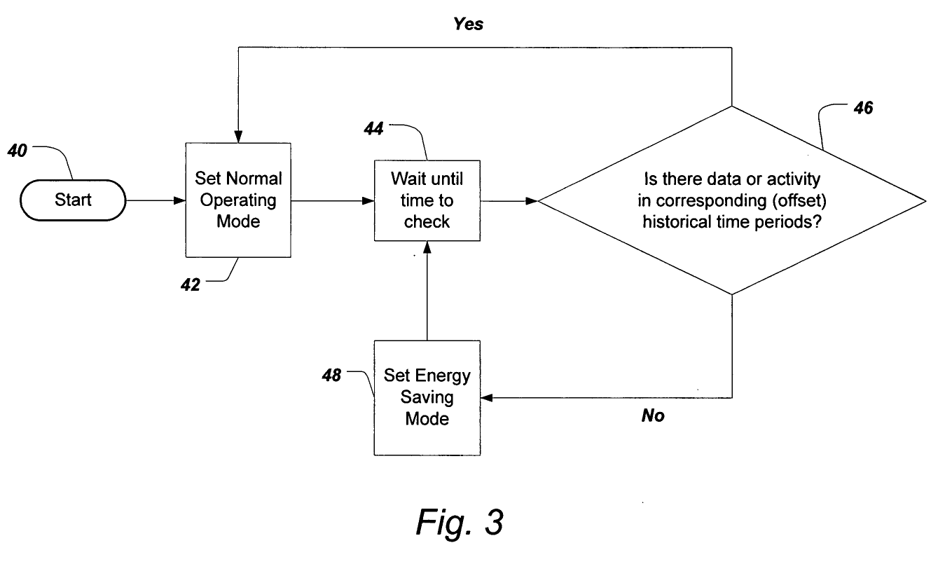

Aspects of the present invention are preferably embodied as software used with a controller 20 of the vending machine 10, including a microprocessor 26, to control the scheduling of the normal and energy saving modes. Operation of embodiments of the present invention may be described with reference to the flowchart of FIG. 3. The vending machine 10 is started up (at 40) and put in the normal operating mode (at 42). The system waits until a required amount of time has passed (for example, based on the value of the resolution) (at 44), and then checks whether there is any vend data or activity in a corresponding historical time period (at 46). For example, if the resolution is set to one hour then the system will check for historical data or activity every hour. Since the system may maintain a number of historical time periods within the historical collection period, each of these may be checked. Note that the historical time period checked here should be offset by the lead time of the machine 10. In other words, it is necessary to look ahead by at least the required lead time. In this manner, when the machine is switched from an energy saving mode into a normal operating mode, the machine will have sufficient time (the lead time) to cool (or heat) the product to the desired vend temperature. If data or activity are detected (at 46), then the vending machine 10 is set to normal operating mode (at 42), otherwise it may be set to energy saving mode (at 48).

As an example, if the maximum lead time for any product in the machine is one hour, then the system should examine the historical data corresponding to one hour after the current time. In this manner, if historic activity or data are found, the machine's mode can be switched over with sufficient time.

In the normal operating mode, the cooling element 14 is operated until the storage compartment 18 reaches the desired temperature (as determined by the temperature sensor 22). In the energy saving mode, the cooling element is turned off and the storage compartment 18 is allowed to warm up to an energy saving temperature (as determined by the temperature sensor 22). Note that the cooling element 14 may still operate during energy saving mode, for example, if needed to keep the temperature at or below the energy saving temperature setting.

### EXAMPLE

The following is an example of the use of the present invention to schedule an energy saving mode for the refrigeration aspects of a vending machine.

Settings:
Standard (ideal vend) temperature setting for product=40° F.
Energy Saving temperature setting for product=50° F.
Historical Vend Data Collection Period=3 weeks
Resolution (length of time period)=1 hour
Offset time=2 hours
Pattern time=1 week

Based on this data, in the case of this example, a product should be stored near 40° F. when in the normal operating mode and near 50° F. when in the energy saving mode. (There is actually a hysterisis at both temperatures. In other words, when the setpoint is 40° F., the cooling element 14 will be activated when the temperature exceeds 40° F. and deactivated when the temperature reaches 36° F. Similar results occur when the temperature is set to 50° F.)

A refrigerated vending machine 10 according to embodiments of the present invention monitors vending activity. Since, in this example, the resolution is set at one hour, the controller 20 records whether any vending has occurred for consecutive one-hour time periods (5:00 AM-5:59 AM, 6:00 AM-6:59 AM, etc.). Since the Historical Vend Data Collection Period has been set for three weeks, when three weeks of data have been accumulated, the machine 10 can start using this data to predict future inactivity. Any of the settings can be altered as desired to provide the most effective predicting and scheduling. These can be altered based on a number of factors, including, but not limited to, the location of the machine, the climate of the location of the machine, possibly adjusted for time of day/year, the specific model of the machine, the operating characteristics of the machine, the product vended by the machine, or other factors.

In this example, the offset or lead time is two hours. That is, it has been determined that it takes two hours (or less) to chill the product to be vended from the Energy Saving temperature setting of 50° F. to the Standard (ideal) temperature setting of 40° F. Thus, for the refrigeration aspects of the machine, the offset (lead) time is set at two hours. That is, the refrigeration aspects of the machine need to be switched from the energy saving mode to the normal operating mode two hours before the first predicted vend of the refrigerated product will occur to assure that the customer receives the vended product at the ideal serving temperature. For lighting, for instance, the offset may be zero because of the relatively instant-on (and instant-off) characteristics of the lighting.

FIG. 3 is a flowchart showing aspects of operation of embodiments of the present invention. This example will follow the logic flow shown in FIG. 3. While this flow chart shows one example or embodiment, variations can be made in the method or logic used without departing from the scope of the invention. When the energy saving machine control is started (at 40), the machine 10 is placed in a normal operating mode (at 42). The machine 10 should not be placed in energy saving mode until sufficient historical vend data has been collected to allow accurate prediction. More specifically, the vending machine 10 should not be put into energy saving mode until it can be done without causing customer dissatisfaction due to vending of product at a non-ideal temperature. (In preferred embodiments, if the machine has been powered off for a long period of time, it will assume that vends could have been made so it will stay in normal operating mode until the appropriate data has been accumulated. Some presently preferred embodiments will include a so-called “reset” option so that an operator can reset the energy logic whenever a machine is placed at a new location. In such cases, the machine assumes that it is in a first time power up and so will not activate the energy savings mode until data are accumulated.) Next, the current date and time are determined, for example, from a clock 27 associated with the machine controller 20.

The vending machine 10 (controller 20) then waits until it is again time to check the history, that is, whether it is time to check for historical vend activity in the respective time period. This may be done by checking whether the Current Time≧Previous Check Time+Resolution Time. In this example, because the resolution is set to one hour, the system will only check for historical vend data every hour.

If it is time to check (as determined at 44), the system checks to see if there were any data or activity in appropriately offset historical time periods. In this example, the Historical Collection Period is three weeks. That is, the process will look at the last three weeks of collected Historical Vend Data, on a rolling basis, to determine whether the machine should be set to the Energy Saving Mode or the Normal Operating Mode. The Pattern Time adds a factor that accounts for a period variation in vend activity. For instance, there may be variations in vend activity depending on the day of the week. While a weekly Pattern Time is probably the most common periodic pattern expected, other Pattern Times can be used, as the circumstances warrant. In this example, the Historical Collection Period is three weeks (21 days) and the Pattern Time is one week (7 days).

The Historical Time Period (“HTP”) is set as the Current Time minus a (counter multiplied by the Pattern Time) plus the Offset Time. The Historical Time Period is distinguished from the Historical Collection Period as follows: The Historical Collection Period is the length of time at which historical vend data will be analyzed in the process and the Historical Time Period is a specific time period within the Historical Collection Period, which may be recurring, such as between 5:00 AM to 5:59 AM on Saturdays.

It will be determined whether there are any vend data available for a specific Historical Time Period in the Historical Collection Period. If there are no such data, as for instance, when the machine is new and has just been installed in a location and started for the first time, the machine will remain in Normal Operating Mode (essentially this is because the absence of data in a period allows the system to consider that period as an active period). If there are vend data available for the Historical Time Period, the process determines whether there was any vend activity in the specific Historical Time Period. That is, was a product vended, or not, during the specific Historical Time Period in question.

If a product was vended, the machine is set to operate in the Normal Operating Mode. In this embodiment, if there has been any vend activity in the respective Historical Time Periods within the Historical Collection Period, it has been determined that there is a reasonable likelihood that there will be vend activity in the upcoming respective Time Period, so the machine should be set to normal Operating Mode to assure that a customer in the upcoming Time Period will receive vended product at an ideal vend temperature. If the machine is already in Normal Operating Mode, no change occurs. If the machine has been in Energy saving Mode, the machine will be reset to operate in Normal Operating Mode. The process can also be set to operate on another basis, as desired, to determine whether the historical vend activity indicates that the machine should be set to normal operating mode. For instance, the Historical Collection Period might be set at 5 weeks and the system might switch the machine to Normal Operating Mode if there has been vend activity in any of the five respective Historical Time Periods within the Historical Collection Period, or alternatively, only if there has been vend activity in at least two of the five respective Historical Time Periods within the Historical Collection Period.

If it has been determined that there was no activity in the Historical Time Period being analyzed, the process determines whether all historical Time Periods have been checked. If not, the process checks the next historical time period. The first Historical Time Period being considered was the selected Historical Time Period for the previous week. (One skilled in the art would realize that it does not really matter in which order the weeks are processed—that is, if it starts with the most recent week or the oldest week—so long as all (or sufficient) are checked for activity.) Embodiments of the invention use a variable counter to check each historical time period in the historical collection data. For example, if the process was checking for the current time period beginning at 5:00 AM Saturday, the vend history considered would be for HTP=Current Time−(Counter×Pattern Time)+Offset Time=5:00 AM Saturday−(1×1 week)+2 hours=5:00 AM Saturday−1 week+2 hours=5:00 AM Saturday one week ago+2 hours=7:00 AM Saturday one week ago. In the second cycle, the HTP being considered is 7:00 AM Saturday two weeks ago. In other words, the HTPs considered are the current time, offset by 2 hours, for the previous one, two and three weeks.

The process will preferably prevent ordering the machine to Energy Saving Mode until there have been three consecutive Historical Time Periods in the Historical Collection Period (in this example) where there has been no vend activity during the time period being considered. These three consecutive time periods of no vend activity have been determined, for this example, to be a good indicator that no vend activity will occur during the time period of 7:00 AM today (Saturday), so the machine can either remain on Energy Saving Mode (if already on such mode) for the time period beginning at 5:00 AM Saturday, or, if currently on Normal Operating Mode, can be switched to Energy Saving Mode.

In this example, at the 5:00 AM Saturday check time, if there has been no vend activity for the time period beginning at 7:00 AM Saturday for the previous three Saturdays, the machine is controlled to remain in the Energy Saving Mode (if already there) and the product is maintained at ˜50° F. or is switched to the Energy Saving Mode (if in Normal Operating Mode) and the temperature of the product is allowed to increase to ˜50° F. If there has been vend activity for the time period beginning at 7:00 AM Saturday for any of the previous three Saturdays, the machine is controlled to remain in the Normal Operating Mode (if already there) and the temperature of the product is maintained at ˜40° F. or is switched to the Normal Operating Mode (if in Energy Saving Mode) and the temperature of the product is chilled to ˜40° F.

While the examples given have assumed that products are to be vended cooled, in some cases products may need to be vended warm (or may need to be warmed because of external environmental causes, for example, the vending machine may be outside in winter). In such cases, the heater element 16 may be operated to raise the temperature of the storage compartment 18.

In situations where the rate at which the product can be chilled is significantly different than the rate at which the product warms, it can be desirable to have two different offset times, one for chilling and one for warming. In such a case, the system may be modified, for example, by determining which mode the machine is in before switching. If the machine is in the Energy Saving Mode and there is a certain offset time O_{C} for chilling the product to the ideal temperature, the process can follow as discussed above using this offset time O_{C}. If on the other hand, the machine is in Normal Operating Mode and there is a different offset time O_{W} by which the product warms, the process can follow through a parallel flow as discussed above but using the offset time O_{W}.

Alternatively, the flow can be modified by adding a decision determining whether the movement from one mode to the other might interfere with a subsequent vend such that the move should be prohibited for the time period at issue.

The above process can be used in a similar manner for other power consumption aspects of a vending machine, including, for instance, a heating unit in a machine that vends warmed product. In such a case, for instance, the Energy Saving Mode would be at a cooler temperature and the Normal Operating Mode would be at a higher temperature.

In some embodiments, if it is detected that there has been a power outage to the machine during a time period of the Historical Vend Data Collection Period, such that the machine was not capable of vending product during such time period, the historical vend data can recorded as having made a vend during such time period, since there is the possibility (and depending on the circumstances, even a probability) that a vend would have occurred in that time period if there had been no power outage.

The historical vend data can be reset as desired when it is determined that vending activity may experience a significant change because of, for example, a change in the location of the machine, a change in the product selection, a seasonal change in work schedules, etc. In such a case, new vend data will be collected for the Historical Collection Period before allowing the Energy Saving Mode to be selected, just as when the machine was new and first started operation. Alternatively, the process can be modified to use predetermined vend history data to determine which mode the machine operates in until the machine has collected sufficient historical vend data of its own to determine the selection of the modes, as discussed above. This predetermined vend history data can be derived based on certain assumptions made about the machine, location and product or can be accessed from the vend history of other machines, particularly, other machines having operated in the same location.

Although only an Energy Saving Mode and a Normal Operating Mode are discussed above, the present invention can use any number of modes, as desired, based on historical vend data. For instance, if the historical vend data predicts that there will be no vend activity for the next four hours, the machine could be ordered to a Super Energy Saving Mode where the temperature of the product is allowed to increase to a temperature greater than 50° F., such as 55° F. The temperatures and modes and other settings and variables can be altered as desired.

None of the known vending machines allow variation of the switch between the modes based on variation in vending history of the machine. The use of occupancy sensors or money input to switch from the energy saving mode to the normal mode will generally result in the customer receiving a warm product, negatively affecting customer satisfaction with the product and possibly reducing future sales from the machine.

The present invention provides the biggest benefit with respect to customer satisfaction with the vend when it is used to control aspects of the machine which require longer periods of time to fully recover from the energy saving mode. For instance, it takes a certain amount of time for the machine to be able to chill product from an energy saving temperature to an ideal serving or vend temperature of the normal operating mode. Thus, predicting when a vend may occur based on historical vend data allows more accurate scheduling of when the temperature of the product should be reduced from the energy saving temperature to the ideal serving temperature, including the necessary lead time to so reduce the temperature, so that the customer is satisfied with the temperature of the vended product.

On the other hand, where the recovery time is relatively short, such as with turning a light from off to on, the use of the present invention may have lesser impact on the satisfaction of the customer with the vend. However, the present invention is still useful with respect to such aspects of the vending machine. For instance, the use of lighting and lighted graphics increase the appeal of the machine and increase sales from the machine, so it is desirable to control the machine to have the most appealing appearance by operating such lighting when it is predicted that customers may use the vending machine.

One skilled in the art will realize that the temperatures discussed herein are used only by way of examples and are not intended to limit the scope of the invention in any way. Further, when a particular temperature is mentioned, one skilled in the art will realize that temperatures close to that temperature may be acceptable. For example, an acceptable vend temperature will generally be a range of temperatures (possibly within a few degrees of the stated temperature).

One skilled in the art will realize that predictions, according to some embodiments of this invention, may be made according to periods of prior activity, inactivity or both.

While a single energy saving schedule can be used for all aspects of the machine that are placed in an energy saving mode, the present invention can also place different power consumption aspects of the machine on different energy saving mode schedules. For instance, because of the longer lead time to return product from an energy saving temperature to an ideal serving temperature, the refrigeration aspects of the machine can be placed on one energy saving schedule while the lighting aspects having shorter lead times to move from an off/dim mode to a fully lighted mode can be placed on another energy saving schedule. The energy saving scheduling of the various power consumption aspects of the machine can be independently varied and controlled as desired.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A vending machine comprising:
a storage compartment; and
a controller programmed to collect historical data about the machine and to control the temperature of the storage compartment based, at least in part, on the collected historical data.

2. A vending machine as in claim 1 wherein the controller is further constructed and programmed to predict periods of inactivity based on past patterns of inactivity.

3. A vending machine as in claim 1, where the controller is further constructed and programmed to reduce energy consumption by the machine during periods of predicted inactivity.

4. The vending machine as in claim 3 wherein energy consumption is reduced by allowing the temperature inside the storage compartment to change nearer to an ambient temperature of the vending machine.

5. The vending machine as in claim 4 wherein the change is from colder to warmer.

6. The vending machine as in claim 4 wherein the change is from warmer to colder.

7. The vending machine as in claim 3 wherein energy consumption is reduced by turning lights or other power-consuming devices off.

8. A vending machine as in claim 1 further comprising:
a cooling element for cooling the storage compartment, and wherein the controller is further constructed and programmed to deactivate the cooling element based, at least in part, on the collected historical data.

9. A vending machine as in claim 1 wherein the controller is further constructed and programmed to predict periods of activity based on past patterns of activity.

10. A vending machine as in claim 9 wherein the controller is further constructed and programmed to increase energy consumption by the machine prior to a period of predicted activity.

11. A vending machine as in claim 10 further comprising a cooling element for cooling the storage compartment, and wherein the controller is further constructed and programmed to activate the cooling element prior to a period of predicted activity.

12. A vending machine as in claim 11, wherein the cooling element is activated in sufficient time to cool stored products to a desired vend temperature.

13. A method of controlling a vending machine, the vending machine having at least two operating modes including a normal operating mode in which items to be vended are maintained at or near a desired vend temperature and an energy saving mode in which items to be vended are allowed to be at a temperature other than the desired vend temperature, the method comprising:
collecting historical operational data about the vending machine;
predicting, based at least in part on the collected historical data, at least one period of potential vend activity; and
putting the vending machine into normal operating mode prior to any predicted period of potential vend activity.

14. A method as in claim 13, wherein the vending machine comprises a refrigerated storage compartment and a cooling element for cooling the storage compartment, the method further comprising:
activating the cooling element when putting the vending machine into normal operating mode.

15. A method as in claim 14, wherein the cooling element is activated to provide sufficient lead time for a product to be vended to cool from a storage temperature to a desired vend temperature by the time of a potential vend activity.

16. A method as in claim 13 further comprising:
putting the vending machine into energy saving mode for predicted periods of inactivity.

17. A method of vending products from a vending machine, the method comprising:
storing the products in the vending machine, wherein at least some of the products are allowed to reach a temperature other than a desired vend temperature;
collecting historical operational data about the vending machine, the data including date and time information about previous vends;
predicting, based at least in part on the collected historical data, a period of potential vend activity; and
prior to the period of potential vend activity, cooling at least some of the products to a desired vend temperature.

18. A method as in claim 17 wherein the cooling begins sufficiently prior to the period of predicted vend activity to allow the products to reach the desired vend temperature by the time of the period of predicted vend activity.

19. A method as in claim 18 wherein the products are sodas and wherein the desired vend temperature is about 34 degrees Fahrenheit.

20. A method as in claim 19, wherein the desired vend temperature is about 32 to 35 degrees Fahrenheit.

21. A soda vending machine comprising:
a storage compartment for storing sodas to be vended at desired vend temperature of about 32 to 35 degrees Fahrenheit;
a cooling element for cooling the storage compartment; and
a controller programmed to:
(a) collect historical data about the operation of the vending machine and to control the temperature of the storage compartment based, at least in part, on the collected historical data,
(b) reduce energy consumption by the vending machine during periods of predicted inactivity by allowing the temperature inside the storage compartment to change nearer to an ambient temperature of the vending machine, and
(c) increase energy consumption by the vending machine prior to a period of predicted activity by causing activation of the cooling element, wherein the cooling element is activated in sufficient time to cool sodas stored in the storage compartment to the desired vend temperature.
